(19) United States
(12) Patent Application Publication
(10) Pub. No.: US 2007/0268906 A1
(43) Pub. Date: Nov. 22, 2007

(54) Information processing apparatus matching respective address data input at plurality of apparatuses and computer program embodies in a computer readable medium executed in information processing apparatus

(75) Inventors: Toshiya Shozaki, Osaka-shi (JP); Kaitaku Ozawa, Itami-shi (JP); Kimie Ando, Kawasaki-shi (JP); Junichi Hase, Osaka-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/642,890

(22) Filed: Dec. 21, 2006

(30) Foreign Application Priority Data
May 16, 2006 (JP) 2006-136814

(51) Int. Cl. H04L 12/56; H04L 12/28

(52) U.S. Cl. 370/392; 370/401

(57) ABSTRACT

To register address data in relation with its registration-source identification information, MFP includes: a obtaining portion for obtaining address data from an apparatus, the address data including destination user identification information identifying a destination user and destination information identifying a destination; a obtaining portion for obtaining apparatus identification information identifying the apparatus; a registration portion for registering destination data in relation with the obtained address data and the obtained apparatus identification information; and a storing portion for storing the destination data registered by the registration portion.

This application is based on Japanese Patent Application No. 2006-136814 filed with Japan Patent Office on May 16, 2006, the entire content of which is hereby incorporated by reference.

### BACKGROUND OF THE INVENTION

1. Field of the Invention

The present invention relates to an information processing apparatus and a computer program embodies in a computer readable medium, and more particularly to an information processing apparatus which matches respective address data input at a plurality of apparatuses and a computer program embodies in a computer readable medium executed in the information processing apparatus.

2. Description of the Related Art

In recent years, some Multi Function Peripherals (referred to as “MFP” hereinafter) have a function of transmitting image data obtained by scanning a document to another computer using a transmission method such as emails or FTP (File Transfer Protocol). In addition, MFP stores address data beforehand in which a recipient name and an address are related to each other, in order to facilitate designation of a recipient. Thus, a recipient can be designated only by selecting and designating one of address data. When MFP is used by a plurality of users, a plurality of persons store their respective address data in MFP thereby increasing the number of address data, which makes it difficult to select desired address data. Such a technique is known in that address data is managed for each user to permit designation only by a user who registered the address data.

On the other hand, address data is stored not only in MFP but also in a personal computer or a mobile phone used by a user. For each apparatus, a user registers the respective address data used in these apparatuses. In each apparatus, the user performs various operations while making full use of the addresses registered for each apparatus according to purposes. For example, in a personal computer, mail addresses for a variety of apparatuses, which are used as transmission destinations of the same user, such as a company mail address, a private mail address, and a mobile phone mail address may be registered as destinations, and in addition to mail addresses, facsimile numbers may also be registered as destinations. On the other hand, in a mobile phone, mobile phone mail addresses are often registered.

However, when the address data registered in each of these apparatuses is registered in MFP, the address registration operations are performed from a plurality of apparatuses so that the registered addresses are inevitably combined. For example, when different addresses for the same recipient name are registered in different apparatuses, the aforementioned address registration operation is confused with an address updating operation because of the same recipient name, so that the address that has already been registered is overwritten with an address from a different apparatus that performs a registration operation later. Therefore, a plurality of addresses cannot be registered for one recipient name.

### SUMMARY OF THE INVENTION

The present invention is made to solve the aforementioned problem. An object of the present invention is to provide an information processing apparatus in which address data can be registered in relation with its registration-source identification information.

Another object of the present invention is to provide a destination data management program product in which address data can be registered in relation with its registration-source apparatus identification information.

To achieve the above-described objects, according to one aspect of the present invention, a information processing apparatus includes: a obtaining portion for obtaining address data from an apparatus, the address data including destination user identification information identifying a destination user and destination information identifying a destination; a obtaining portion for obtaining apparatus identification information identifying the apparatus; a registration portion for registering destination data in relation with the obtained address data and the obtained apparatus identification information; and a storing portion for storing the destination data registered by the registration portion.

According to another aspect of the present invention, an information processing apparatus includes a obtaining portion for obtaining address data from an apparatus, the address data including destination user identification information identifying a destination user and destination information identifying a destination; a obtaining portion for obtaining apparatus identification information identifying the apparatus; a obtaining portion for obtaining registration user information identifying a user registered the address data; a registration portion for registering destination data in relation with the obtained address data and the obtained apparatus identification information; and a storing portion for storing the destination data registered by the registration portion.

According to a further aspect of the present invention, a computer program embodies in a computer readable medium for performing the steps of obtaining address data from an apparatus, the address data including destination user identification information identifying a destination user and destination information identifying a destination; obtaining apparatus identification information identifying the apparatus; registering destination data in relation with the obtained address data and the obtained apparatus identification information.

According to a further aspect of the present invention, a computer program embodies in a computer readable medium for performing the steps of obtaining address data from an apparatus, the address data including destination user identification information identifying a destination user and destination information identifying a destination; obtaining apparatus identification information identifying the apparatus; registering destination data in relation with the obtained address data and the obtained apparatus identification information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of a network system according to an embodiment of the present invention.

FIG. 2 is a block diagram showing an exemplary hardware configuration of MFP according to this embodiment.

FIG. 3 is a functional block diagram showing an overall function of CPU included in MFP.

FIG. 4 is a diagram showing an exemplary hardware configuration of a computer.

FIG. 5 is a flowchart showing a flow of an address data transmission process performed by the computer.

FIG. 6 is a diagram showing exemplary address data.

FIG. 7 is a flowchart illustrating an exemplary flow of a destination data registration process performed in MFP according to the present embodiment.

FIG. 8 is a diagram showing an exemplary warning window.

FIG. 9 is a diagram showing exemplary destination data.

FIG. 10 is a diagram showing updated destination data by way of example.

FIG. 11 is a flowchart illustrating a flow of an address display process performed in MFP according to the present embodiment.

FIG. 12 is a flowchart illustrating an exemplary user-basis display process.

FIGS. 13A and 13B are diagrams showing exemplary display windows displayed when the user-basis display process is performed.

FIG. 14 is a flowchart illustrating an exemplary apparatus-basis display process.

FIGS. 15A and 15B are diagrams showing exemplary display windows displayed when the apparatus-basis display process is performed.

FIG. 16 is a diagram showing an exemplary destination data display window.

FIG. 17 is a flowchart illustrating an exemplary display all process.

FIGS. 18A and 18B are diagrams showing exemplary display windows displayed when the display all process is performed.

### DESCRIPTION OF THE PREFERRED EMBODIMENTS

The embodiment of the present invention will be described below with reference to the drawings. In the following description, the same parts are denoted by the same reference characters. Their names and function are also the same. Thus, a detailed description thereof will not be repeated.

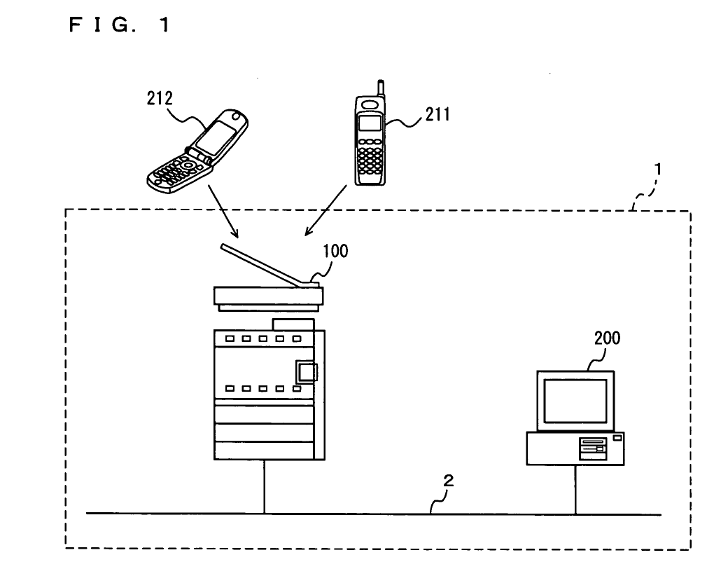

FIG. 1 is a diagram showing an overall configuration of a network system according to an embodiment of the present invention. With reference to FIG. 1, a network system 1 includes a plurality of information processing apparatuses connected to a network 2. Here, as information processing apparatuses, MFP (Multi Function Peripheral) 100 and a computer 200 are connected to network 2. MFP 100 includes a scanner for reading a sheet of original manuscript to obtain image data, an image forming portion for forming an image on recording media such as a sheet of paper based on image data, and a facsimile, and has an image reading function, a copying function, and a facsimile transmission and reception function. MFP 100 communicates data with a mobile phone A211 or a mobile phone B212 and can receive and transmit data. Here, MFP 100 is connected to mobile phone A211 and mobile phone B212 via Public Switched Telephone Networks (PSTN). Computer 200 is a general personal computer and its hardware configuration is well known. Therefore, description thereof will not be repeated here. MFP 100 communicates with mobile phone A211, mobile phone B212 or computer 200 to receive each address data stored by mobile phone A211, mobile phone B212 or computer 200. It is noted that although here MFP 100 is connected to mobile phone A211 or mobile phone B212 via PSTN by way of example, MFP 100 may be provided with a communication interface for connecting with mobile phone A211 or mobile phone B212. The communication interface may be wireless such as infrared communications or may be wired.

Network 2 is a local area network (LAN) and the form of connection can be wired or wireless. In addition, network 2 is not limited to a LAN and can be a wide area network (WAN) such as the Internet, a network using PSTN, and so on.

It is noted that although the figure shows that network system 1 is configured such that one MFP 100 and one computer 2 are connected to network 2 by way of example, the equipment included in network system 1 may be a facsimile, a scanner, a printer, or a computer as long as it can be connected to network 2. Furthermore, the number of equipment included in network system 1 is not limited thereto.

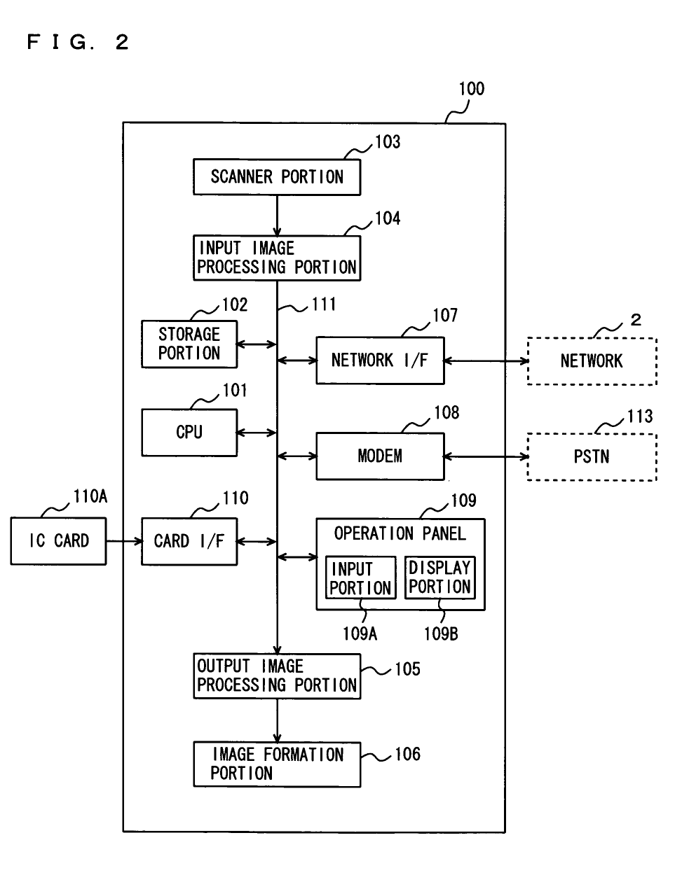

FIG. 2 is a block diagram showing an exemplary hardware configuration of MFP according to this embodiment. With reference to FIG. 2, MFP 100 includes a scanner portion 103, an image formation portion 106 forming an image on a recording medium such as paper, and a CPU (Central Processing Unit) 101, a storage portion 102, an input image processing portion 104 processing image data output by scanner portion 103, an output image processing portion 105 performing processing suitable to output image data, a network interface (I/F) 107, a modem 108, an operation panel 109, and a card I/F 110, each connected to a bus 111.

CPU 101 controls MFP 100 as a whole. Storage portion 102 includes a semiconductor memory such as a ROM (Read Only Memory), a RAM (Random Access Memory) and an EEPROM (Electrically Erasable Programmable ROM) and a magnetic storage device such as a hard disk drive (HDD). CPU 101 loads a destination data management program stored in ROM into RAM for execution.

Scanner portion 103 includes a photoelectric transducer such as a CCD (Charge Coupled Device) and the like, and optically reads a document and outputs image data as electronic data to input image processing portion 104. Input image processing portion 104 performs a color conversion process, a color correction process, a resolution conversion process, a region determination process, and the like for the input image data, and stores the processed image data into storage portion 102.

Output image processing portion 105 reads image data from storage portion 102, performs a screen control process, a smoothing process, a pulse width modulation (PWM), and outputs the processed image to image formation portion 106. Image formation portion 106 is a laser printer and visualizes image data input from output image processing portion 105 on a recording medium such as paper. Image formation portion 106 forms an image using toner of four colors including yellow, magenta, cyan, and black, in the case of color printing. Image formation portion 106 may be an inkjet printer.

An IC card 110A is inserted into card I/F 110. CPU 101 can access IC card 110A through card I/F 110. Network I/F 107 allows MFP 100 to connect to network 2. Network I/F 107 outputs data to network 2 according to a prescribed communication protocol and receives data from network 2 according to a prescribed communication protocol. CPU 101 can communicate with computer 200 connected to network 2 through network I/F 107. Therefore, data can be received/transmitted using, for example, FTP (File Transfer Protocol).

Modem 108 allows MFP 100 to connect to PSTN 113. Modem 108 allows facsimile communications of data according to a facsimile communication protocol. Modem 108 stores the faxed data into HDD of storage portion 102. Furthermore, modem 108 includes an NCU (Network Control Unit) to allow communications with a computer connected to PSTN 113. Data received from anther computer through modem 108 is stored in HDD of storage portion 102.

Operation panel 109 includes an input portion 109A and a display portion 109B. Input portion 109A is an input device such as a touch panel, a keyboard, or a mouse for accepting an input of operation by a user of MFP 100. Display portion 109B is a liquid crystal display or an organic EL (Electro-Luminescence) display panel. When using a touch panel formed of a transparent member for input portion 109A, the touch panel is provided to overlap display portion 109B so that an instruction on a button displayed on display portion 109B can be detected. Thus, a variety of operations can be input.

It is noted that the destination data management program executed in CPU 101 is not limited to the one stored in ROM and may be stored in EEPROM. If stored in EEPROM, the destination data management program can be overwritten or additionally written. Therefore, computer 200 connected to network 2 can overwrite the destination data management program stored in EEPROM of MFP 100 or additionally write a new destination data management program. Furthermore, MFP 100 can download a destination data management program from computer 200 connected to network 2 and store that destination data management program in EEPROM.

Furthermore, the destination data management program may be stored in IC card 110A so that the destination data management program stored in IC card 110A inserted into card I/F 110 is loaded into RAM for execution. It is noted that the destination data management program may be recorded not only in IC card 110A but also in a medium including a magnetic tape, a cassette tape, a magnetic disk (flexible disk, hard disk, or the like), an optical disk (CD-ROM (Compact Disc-ROM)/MO (Magneto-Optical Disc)/MD (Mini Disc)/DVD (Digital Versatile Disc) or the like), an optical card, or a semiconductor memory such as a mask ROM or a flash memory. The program referred to herein includes not only a program directly executable by CPU 101 but also a program in a source program format, a compressed program, an encrypted program, or the like.

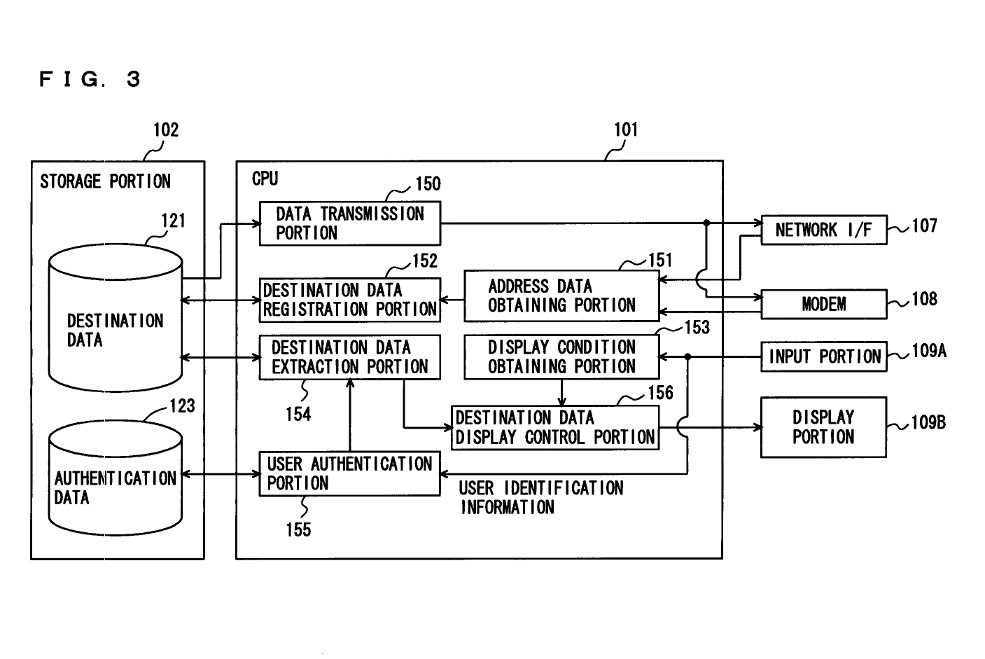

FIG. 3 is a functional block diagram showing an overall function of CPU included in MFP. Referring to FIG. 3, CPU 101 includes a data transmission portion 150, an address data obtaining portion 151, a destination data registration portion 152, a display condition obtaining portion 153, a user authentication portion 155 for authenticating a user, a destination data extraction portion 154, and a destination data display control portion 156. Storage portion 102 stores destination data 121 and authentication data 123. The destination data includes an address for specifying a destination (referred to as “destination address” hereinafter), user identification information for identifying a destination user (referred to as “destination user identification information” hereinafter), apparatus identification information for identifying an apparatus that has registered the destination data (referred to as “registration-source apparatus identification information” hereinafter), and user identification information for identifying a user who gave an instruction to record the destination data (referred to as “registration user identification information” hereinafter). The authentication information is information for authenticating a user and here is formed of a user ID and a password. The user ID may be user identification information. It is noted that authentication information may be biometric information.

Data transmission portion 150 causes a transmission instruction window for designating data for transmission and destination data 121 to appear on display portion 109B, and upon designation of data and destination data 121 on input portion 109A by a user, reads the designated destination data 121 from storage portion 102 and transmits the designated data to the destination address specified by destination data 121 through network I/F 107. Furthermore, data transmission portion 150 transmits the transmission instruction window to computer 200 in response to a request from computer 200 connected to network 200 and upon reception of data and destination data 121 from computer 200, reads the designated destination data 121 from storage portion 102 and transmits the designated data to the destination address specified by destination data 121 through network I/F 107. It is noted that data transmission portion 150 outputs data from modem 108 depending on the destination address.

User authentication portion 155 causes an authentication window for inputting authentication information to appear on display portion 109B, and upon input of authentication information to input portion 109A by a user, obtains the authentication information input to input portion 109A and compares the authentication information with authentication data 123 stored in storage portion 102. Furthermore, user authentication portion 155 transmits the authentication window to computer 200 in response to a request from computer 200 connected to network 2, and upon reception of authentication information from computer 200, compares the received authentication information with authentication data 123 stored in storage portion 102. If authentication data 123 that matches the authentication information is stored, user authentication portion 155 authenticates the user to permit log-in. User authentication portion 155 outputs the authentication result to destination data extraction portion 154. The authentication result includes user identification information for identifying the user, if the user authentication is successful, and includes information indicating authentication is failed, if the user authentication is failed.

Address data obtaining portion 151 receives apparatus identification information for identifying computer 200 from computer 200 through network I/F 107, user identification information for identifying a user who operates computer 200, and address data. The apparatus identification information is registration-source apparatus identification information. The address data includes a destination address and destination user identification information. The destination address may be a facsimile number other than an email address. The destination address represents destination information. When a user operates computer 200 to transmit address data to MFP 100 to give an instruction of registration, the address data owned by that user is transmitted. Therefore, user identification information for identifying a user who operates computer 200 is user identification information for identifying a user who instructs MFP 100 to obtain address data, which is registration user identification information. Furthermore, address data obtaining portion 151 receives apparatus identification information for identifying mobile phone A211 (or mobile phone B212) from mobile phone A211 (or mobile phone B212), user identification information for identifying a user who operates mobile phone A211 (or mobile phone B212), and address data through modem 108. The apparatus identification information is registration-source apparatus identification information. When a user operates mobile phone A211 or mobile phone B212 to transmit address data to MFP 100 to give an instruction of registration, the address data owned by that user is transmitted. Therefore, user identification information for identifying a user who operates mobile phone A211 or mobile phone B212 is user identification information for identifying a user who instructs MFP 100 to obtain address data, which is registration user identification information. Address data obtaining portion 151 outputs the received address data, apparatus identification information, and registration user identification information to destination data registration portion 152. It is noted that address data obtaining portion 151 may receive registration user identification information from user authentication portion 155. In this case, address data obtaining portion 151 receives apparatus identification information for identifying mobile phone A211 (or mobile phone B212) and address data from mobile phone A211 (or mobile phone B212) through modem 108 and receives registration user identification information from user authentication portion 155.

Destination data registration portion 152 receives address data, registration-source apparatus identification information, and registration user identification information from address data obtaining portion 151. Destination data registration portion 152 extracts destination data that includes registration-source apparatus identification information and registration user identification information input from address data obtaining portion 151, from destination data 121 stored in storage portion 102. Then, if there exists in the extracted destination data 121, destination data 121 in which either one of destination user identification information and destination information of the address data input from address data obtaining portion 151 is matched, destination data registration portion 152 changes the address data of that destination data 121 to the address data input from address data obtaining portion 151. Accordingly, the address data changed in the apparatus from which address data obtaining portion 151 obtains address data can be reflected in destination data 121. On the other hand, if there does not exist in the extracted destination data 121, destination data in which at least one of destination user identification information and destination information of the address data input from address data obtaining portion 151 is matched, destination data registration portion 152 newly registers destination data in which the address data, registration-source apparatus identification information, and registration user identification information input from address data obtaining portion 151 are related with one another, and additionally stores the same in storage portion 102. Accordingly, destination data 121 corresponding to address data newly added in the apparatus from which address data obtaining portion 151 obtains address data is newly added, registered and stored in storage portion 102. In addition, destination data registration portion 152 does nothing if there exists in the extracted destination data 121, destination data in which both of destination user identification information and destination information of the address data input from address data obtaining portion 151 are matched.

Destination data extraction portion 154 receives an authentication result from user authentication portion 155. Destination data extraction portion 154 performs different processes between when MFP 100 is set in security mode ON and when MFP 100 is set in security mode OFF. The security mode of MFP 100 is set by the user of MFP 100, preferably, the user who administrates MFP 100. If MFP 100 is set in security mode ON, upon reception of an authentication result including user identification information from user authentication portion 155, destination data extraction portion 154 reads destination data 121 having registration user identification information that matches the user identification information from storage portion 102 and outputs the read destination data 121 to destination data display control portion 156. If MFP 100 is set in security mode ON, upon reception of an authentication result including information indicating that authentication is failed from user authentication portion 155, destination data extraction portion 154 does not read destination data 121 from storage portion 102 and outputs nothing to destination data display control portion 156. If MFP 100 is set in security mode OFF, destination data extraction portion 154 reads all destination data 121 from storage portion 102 for output to destination data display control portion 156.

Display condition obtaining portion 153 causes a display condition instruction window for designating a display condition for extracting destination data to appear on display portion 109B, and upon designation of a display condition on input portion 109A by the user, obtains the designated display condition. Furthermore, display condition obtaining portion 153 transmits the display condition instruction window to computer 200 in response to a request from computer 200 connected to network 2, and receives a display condition from computer 200 thereby obtaining a display condition. Display condition obtaining portion 153 outputs the obtained display condition to destination data display control portion 156. The display condition here includes apparatus-basis display in which destination data is displayed on a registered apparatus basis and user-basis display in which destination data is displayed on a registered user basis.

Destination data display control portion 156 receives a display condition from display condition obtaining portion 153 and receives destination data from destination data extraction portion 154. Destination data display control portion 156 classifies destination data into a plurality of groups according to the display condition and displays destination data for each group. Specifically, if the display condition is apparatus-basis display, destination data display control portion 156 puts together destination data having the same registration-source apparatus identification information into the same group and displays the destination data for each group on display portion 109B. If the display condition is user-basis display, destination data display control portion 156 puts together destination data having the same registration user identification information into the same group and displays the destination data for each group. If display condition obtaining portion 153 obtains a display condition from computer 200 connected to network 2, destination data display control portion 156 transmits the destination data classified into groups according to the display condition to computer 200 that transmitted the display condition via network I/F 107.

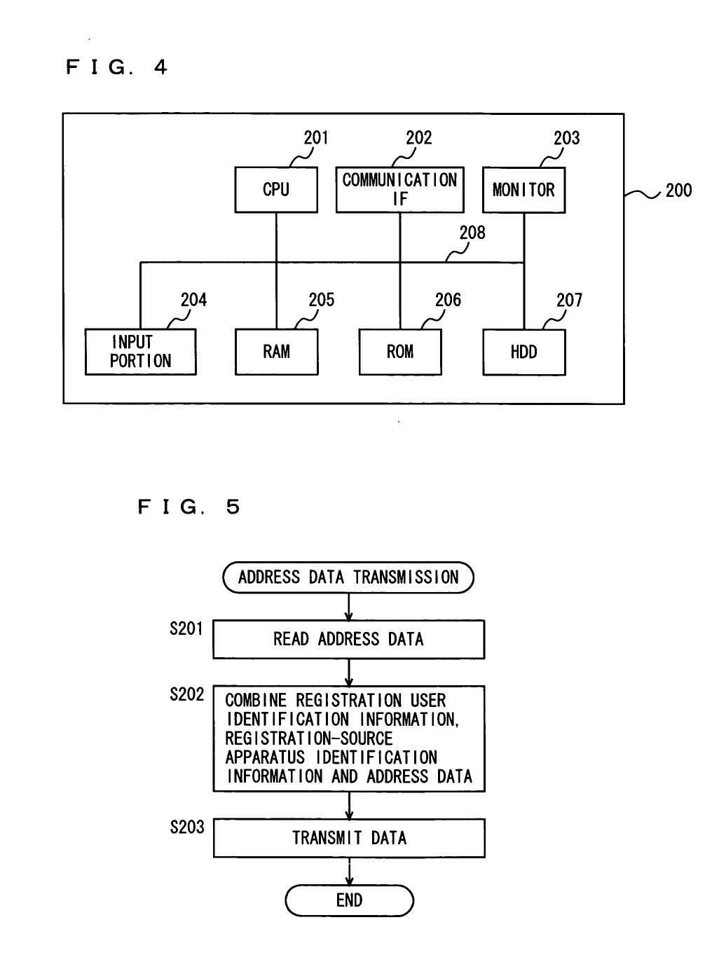

FIG. 4 is a diagram showing an exemplary hardware configuration of computer 200. Referring to FIG. 4, computer 200 includes a CPU 201, a RAM 205 for use as a work area for CPU 201, a ROM 206 storing a program executed by CPU 201, a hard disk drive (HDD) 207, a communication I/F 202 for connecting computer 200 to network 2, an input portion 204 such as a keyboard and mouse, and a monitor 203, each connected to a bus 208.

FIG. 5 is a flowchart showing a flow of an address data transmission process performed by computer 200. The address data transmission process is performed in CPU 201, by CPU 201 loading an address data transmission program recorded in ROM 206 into RAM 205 for execution. Referring to FIG. 5, CPU 201 reads address data stored in HDD 207 (step S201). Then, registration user identification information, registration-source apparatus identification information, and address data are combined (step S202). The registration-source apparatus identification information is apparatus identification information for identifying computer 200 and may be stored in computer 200 beforehand. The registration user identification information is user identification information for identifying a user who operates computer 200 and is input into computer 200 by the user, who is the operator, inputting user identification information when operating computer 200. Then, the combined registration user identification information, registration-source apparatus identification information and address data is transmitted to MFP 100 (step S203).

It is noted that although here the data transmission process is performed in computer 200 by way of example, it may be performed similarly in mobile phones A211, B212.

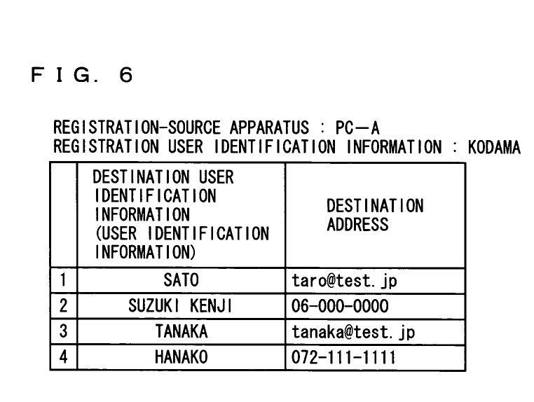

The address data transmitted by computer 200 will now be described. FIG. 6 is a diagram showing exemplary address data. Referring to FIG. 6, this address data shows the address data of a user “Kodama” stored in computer 200. Thus, the registration-source apparatus identification information is apparatus identification information “PC-A” of computer 200, and the registration user identification information is user identification information “Kodama” of the user “Kodama” who owns the address data. The address data is data in which destination user identification information and a destination address are related with each other. Therefore, the address data has a different destination address if destination user identification information differs.

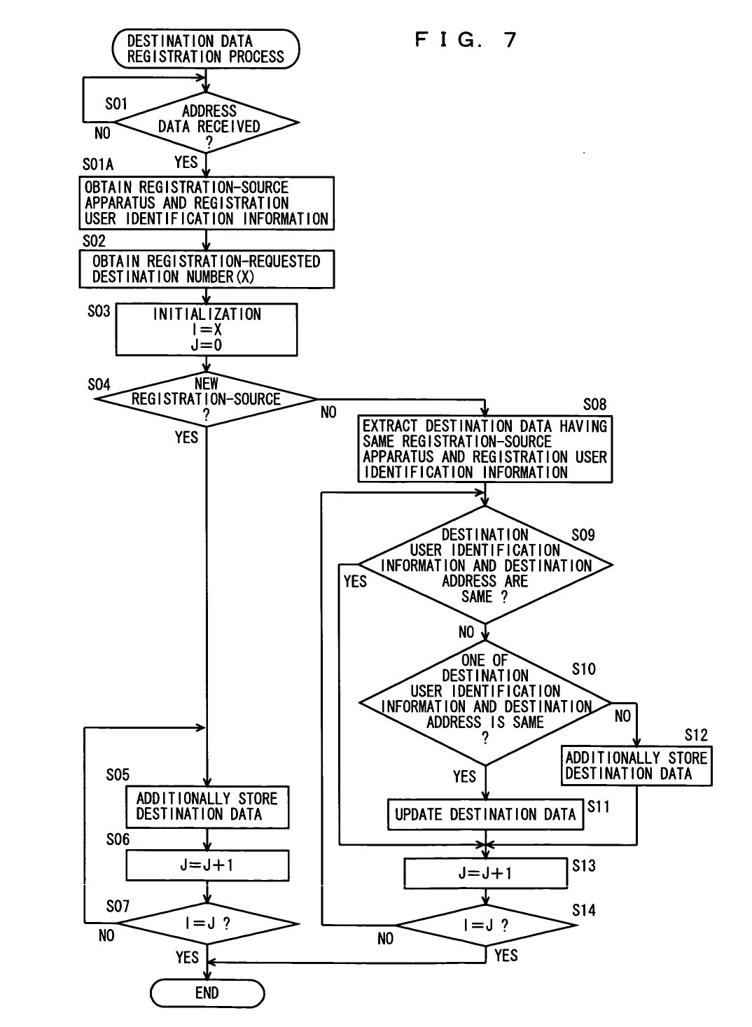

FIG. 7 is a flowchart illustrating an exemplary flow of a destination data registration process performed in MFP according to the present embodiment. This destination data registration process is performed in CPU 101, by CPU 101 of MFP 100 loading a destination data management program stored in ROM of storage portion 102 for execution. Referring to FIG. 7, CPU 101 determines whether or not address data has been received (step S01). The address data includes a destination address and destination user identification information. CPU 101 receives address data from computer 200 via network I/F 107 or from mobile phone A211 (or mobile phone B212) via modem 108. If address data is received from computer 200 via network I/F 107, CPU 101 receives apparatus identification information for identifying computer 200 and user identification information for identifying a user who operates computer 200, in addition to the address data (step S01A). The apparatus identification information for identifying computer 200 is registration-source apparatus identification information, and the user identification information for identifying a user who operates computer 200 is registration user identification information. On the other hand, if address data is received from mobile phone A211 (or mobile phone B212) via modem 108, CPU 101 receives apparatus identification information for identifying mobile phone A211 (or mobile phone B212) and user identification information for identifying a user who operates mobile phone A211 (or mobile phone B212), together with the address data. The apparatus identification information for identifying mobile phone A211 (or mobile phone B212) is registration-source apparatus identification information, and the user identification information for identifying a user who operates mobile phone A211 (or mobile phone B212) is registration user identification information.

CPU 101 obtains the number of address data based on the received address data as a registration-requested destination number (X) (step S02). Then, CPU 101 initializes variable I and variable J (step S03). Variable I has registration-requested destination number X set therein and is used to store a registration-requested destination number. Variable J is used to count the number of the processed address data.

CPU 101 determines whether or not the apparatus that transmitted address data is a new registration-source (step S04). Specifically, when address data is received at step S01, it is determined whether or not the destination data including the registration-source apparatus identification information received with the address data exists in destination data 121 stored in storage portion 102. If destination data including the received registration-source apparatus identification information is not stored in storage portion 102, CPU 101 determines that the apparatus is a new registration-source, and the process proceeds to step S05. If such destination data is stored in storage portion 102, CPU determines that the apparatus is not a new registration-source, and the process proceeds to step S08.

At step S05, CPU 101 selects address data received at step S01 one by one, generates destination data in which the selected address data and the registration-source apparatus identification information and registration user identification information received together with the address data are related with each other, and additionally stores the generated destination data in destination data 121 in storage portion 102. Then, CPU 101 increments variable J by 1 (step S06), and the process proceeds to step S07. At step S07, CPU 101 compares variable J with variable I storing registration-requested destination number X. If they are equal, the process ends, and if they are not equal, the process returns to step S05. Accordingly, if a plurality of address data is received from a new registration-source at step S01, each of a plurality of address data is stored in storage portion 102 as destination data 121 in which each address data is related with registration-source apparatus identification information and registration user identification information.

The process proceeds to step S08, if destination data that includes apparatus identification information of the apparatus that transmitted the address data received at step S01 has already been stored in storage portion 102. At step S08, CPU 101 extracts destination data that includes registration-source apparatus identification information and registration user identification information received together with address data at step S01 from destination data 121 stored in storage portion 102. Then, CPU 101 temporarily stores the extracted destination data in RAM of storage portion 102, selects the address data received at step S01 one by one, and performs the following process for the selected address data and the extracted destination data.

At step S09, CPU 101 determines whether or not such destination data exists in the destination data extracted at step S08, in that both of the destination user identification information and the destination address are the same as the selected address data. If such destination data exists, CPU 101 proceeds to step S13, and if not exist, the process proceeds to step S10. At step S10, CPU 101 determines whether or not such destination data exists in the destination data extracted at step S08, in that either one of the destination user identification information and the destination address is the same as the selected address data. If such destination data exists, CPU 101 specifies that destination data, and the process proceeds to step S11. If not exist, the process proceeds to step S12. At step S11, CPU 101 updates destination data 121 stored in storage portion 102 by changing the destination user identification information and the destination address of the destination data specified at step S10 to the destination user identification information and the destination address of the address data selected at step S08. CPU 101 then proceeds to step S13.

At step S12, CPU 101 generates destination data in which the selected address data and the registration-source apparatus identification information and registration user identification information received together with the address data are related with each other, and additionally stores the generated destination data in destination data 121 in storage portion 102. CPU 101 then proceeds to step S13.

At step S13, CPU 101 increments variable J by 1 and selects the next address data, and the process proceeds to step S14. At step S14, variable J is compared with variable I storing registration-requested destination number X. If they are equal, the process ends, and if they are not equal, the process returns to step S09. Accordingly, when a plurality of address data is received from an apparatus other than a new registration-source, CPU 101 changes a destination address of destination data 121 stored in storage portion 102 based on that address data of a plurality of address data which has a changed destination address or destination user identification information, generates new destination data based on the newly registered address data of a plurality of address data, and additionally stores the new destination data in storage portion 102.

CPU 101 may update destination data 121 at step S11 on condition that a user's permission is input. In this case, CPU 101 causes a warning window to appear on display portion 109B, and when the user inputs an update permission instruction or a registration cancel instruction in input portion 109A, CPU 101 obtains the update permission instruction or the registration cancel instruction input to input portion 109A. If CPU 101 obtains an update permission instruction, CPU 101 updates destination data 121. If CPU 101 obtains a registration cancel instruction, the process proceeds to step S13 without updating.

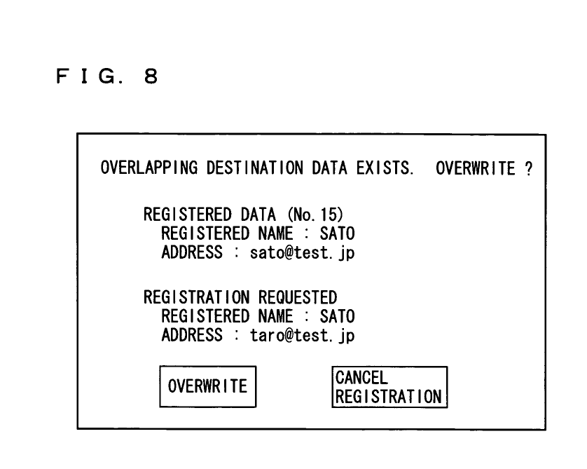

FIG. 8 is a diagram showing an exemplary warning window. Referring to FIG. 8, the destination address of the destination data specified at step S09 is displayed in the address field of the already-registered data, and the registration user identification information of the destination data specified at step S09 is displayed in the registered name field. In addition, the destination address of the selected address data is displayed in the address field of the registration request, and the registration user identification information of the selected address data is displayed in the registered name filed. Accordingly, the user can confirm which destination address of destination data 121 is to be updated based on new address data. The warning window includes an update permission instruction button with characters “overwrite” and a registration cancel button with characters “cancel registration”. When the user specifies the update permission instruction button by input portion 109A, input portion 109A accepts an update permission instruction, so that CPU 101 obtains the update permission instruction. When the user specifies the registration cancel button by input portion 109A, input portion 109A accepts a registration cancel instruction, so that CPU 101 obtains the registration cancel instruction.

There has already been proposed a system that allows automatic registration and update based on address data collectively managed in a server or the like. However, address data used in each apparatus of a plurality of apparatuses is updated by an operation of an individual user and thus cannot be handled by the conventional automatic update of server-based collectively-managed addresses. The address data stored in a personal computer or a mobile phone frequently used by a user is assumed to undergo frequent updating such as addition or changing an address. For individual address data registered in MFP, it is cumbersome for the user to pick up address data one by one to be changed or added. As described above, address data is collectively received at MFP from each apparatus and added and changed based on the registration-source apparatus identification information, thereby significantly improving the user's convenience.

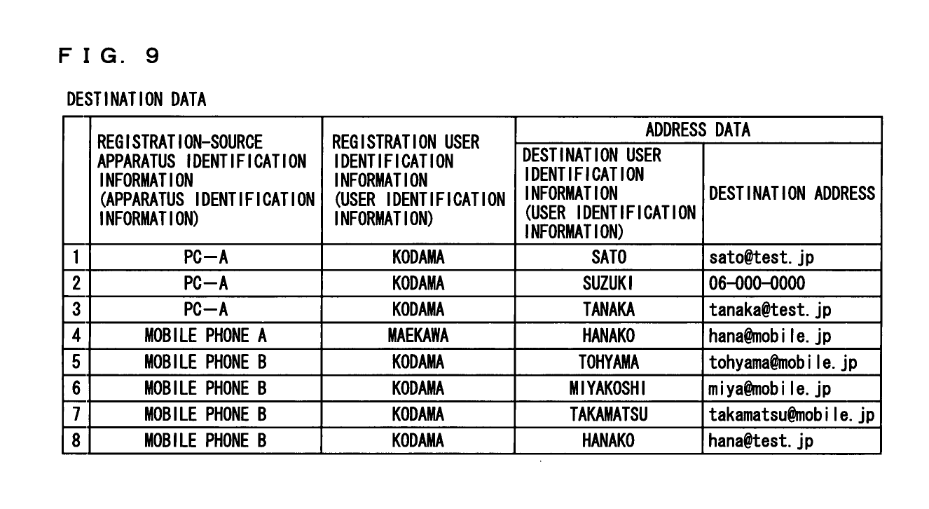

FIG. 9 is a diagram showing exemplary destination data. Referring to FIG. 9, destination data includes registration-source apparatus identification information, registration user identification information, and address data. The address data includes destination user identification information and a destination address. The registration-source apparatus identification information is apparatus identification information for identifying an apparatus that has transmitted address data. The registration user identification information is user identification information for identifying a user who has instructed MFP 100 to obtain address data in order to register address data in MFP 100. The user specified by the registration user identification information may be a user who gave an instruction to transmit address data from computer 200 or a user who gave an instruction to perform the above-noted destination data registration process by operating MPF 100. The destination user identification information is the same as the destination user identification information of address data and is user identification information for specifying a user who receives data. The destination address is the same as the destination address of address data and is an address to which data is transmitted. Here, the destination address is an email address or a facsimile number. The destination data differs if either one of registration-source apparatus identification information and registration user identification information differs even if both of destination user identification information and a destination address are the same.

FIG. 10 is a diagram showing updated destination data by way of example. The destination data shown here is created by updating the destination data shown in FIG. 9 with the address data shown in FIG. 6. A specific example of a destination data registration process will be described with reference to FIG. 9 and FIG. 10. First, destination data Nos. 1-3 having registration-source apparatus identification information “PC-A” and registration user identification information “Kodama” are extracted from the destination data. Destination data Nos. 1-3 extracted from the destination data originally registered in MFP 100 are compared with the newly obtained address data one by one. First, the newly obtained address data No. 1 is selected, and destination data No. 1 having the destination user identification information matching that of address data No. 1 is specified. Since the destination addresses are different between address data No. 1 and destination data No. 1, the destination address of destination data No. 1 is changed to the destination address of address data No. 1. Then, No. 2 address data is selected, and destination data No. 2 having the matching destination address is specified. Since the destination user identification information are different between address data No. 2 and destination data No. 2, the destination user identification information of destination data No. 2 is changed to the destination user identification information of address data No. 2. Then, address data No. 3 is selected, and destination data No. 3 having the matching destination user identification information and destination address is specified. Since both the destination user identification information and the destination address are the same between address data No. 3 and destination data No. 3, destination data No. 3 is not changed. Finally, address data No. 4 is selected, and destination data in which at least one of destination user identification information and destination address is matched does not exist in destination data No. 1-No. 3. Thus, destination data No. 8 is newly registered and additionally stored in storage portion 102, where registration-source apparatus identification information is “PC-A”, registration user identification information is “Kodama”, destination user identification information is “Hanako”, and a destination address is “072-111-1111”.

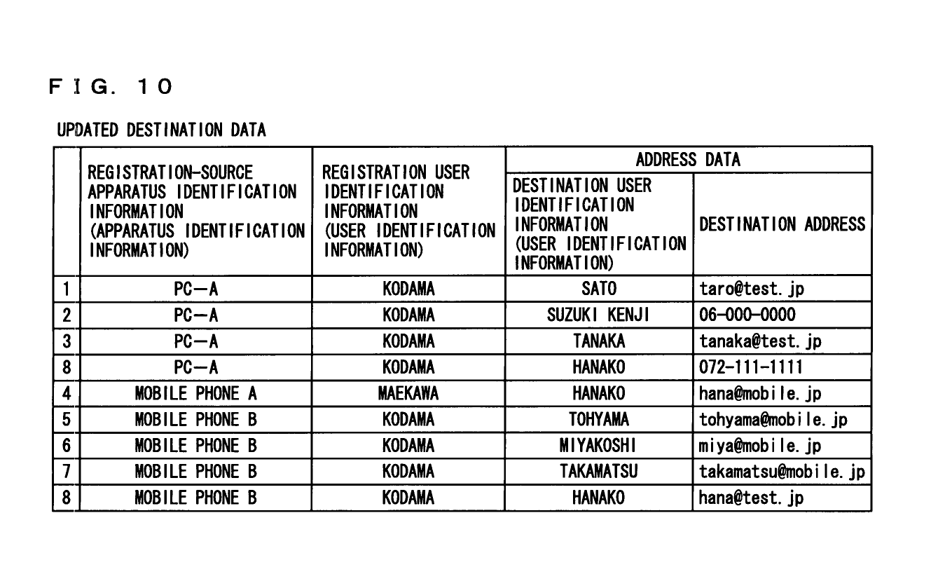

FIG. 11 is a flowchart illustrating a flow of an address display process performed in MFP in accordance with the present embodiment. This address display process is performed in CPU 101 by CPU 101 of MPF 100 loading and executing the destination data management program stored in ROM of storage portion 102. Referring to FIG. 11, CPU 101 obtains authentication information of a user who operates MPF 100 (step S21). Specifically, CPU 101 causes a login window to appear on display portion 109B. The user inputs authentication information to input portion 109A, so that input portion 109A accepts the authentication information, and CPU 101 obtains the authentication information from input portion 109A. When CPU 101 obtains the authentication information, the process proceeds to step S22 for user authentication (step S22). CPU 101 compares the obtained authentication information with authentication data 123 stored beforehand in storage portion 102 and authenticates the user if authentication data 123 that matches the obtained authentication information is stored in storage portion 102. Then, the process proceeds to step S23 (OK at step S22). On the other hand, if authentication data 123 that matches the obtained authentication information is not stored in storage portion 102, the process returns to step S21 without user authentication (NG at step S22).

At step S23, CPU 101 determines whether or not MFP 100 is set in a user-basis display mode. If MFP 100 is set in the user-basis display mode, CPU 101 proceeds to step S24. If MFP 100 is not set in the user-basis display mode, the process proceeds to step S25. At step S25, CPU 101 determines whether or not MFP 100 is set in an apparatus-basis display mode. If MFP 100 is set in the apparatus-basis display mode, CPU 101 proceeds to step S26. If MFP 100 is not set in the apparatus-basis display mode, the process proceeds to step S27. MFP 100 can be set in any of the user-basis display mode, the apparatus-basis display mode and the display all mode. MFP 100 is set in any of the user-basis display mode, the apparatus-basis display mode and the display all mode by the user of MFP 100 operating input portion 109A. In other words, in which display mode MFP 100 is set among the user-basis display mode, the apparatus-basis display mode and the display all mode is determined by the user's intention. CPU 101 performs a user-basis display process at step S24, performs an apparatus-basis display process at step S26, and performs a display all mode process at step S27.

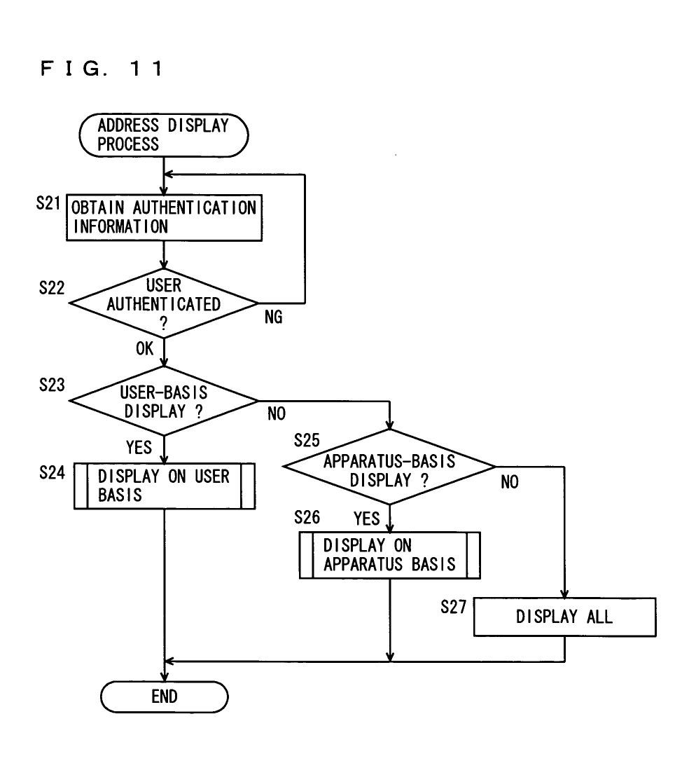

FIG. 12 is a flowchart illustrating an exemplary user-basis display process. Referring to FIG. 12, CPU 101 determines whether or not MFP 100 is set in security mode ON (step S31). MFP 100 can be set in either security mode ON or OFF. MFP 100 is set in either security mode ON or OFF by the user of MFP 100 operating input portion 109A. In other words, whether MFP 100 is set in security mode ON or OFF is determined by the user's intention. The user here is preferably a user who administrates MFP 100. If MFP 100 is set in security mode ON, CPU 101 proceeds to step S32. If MFP 100 is set in security mode OFF, CPU 101 proceeds to step S34. At step S32, CPU 101 extracts destination data of the log-in user who was authenticated. CPU 101 extracts destination data whose registration user identification information is the user identification information of the authenticated log-in user, from destination data 121 stored in storage portion 102. Then, CPU 101 assumes that the extracted destination data is to be displayed, and the process proceeds to step S33. At step S33, the destination data extracted at step S32 is displayed on display portion 109B. On the other hand, at step S34, assuming that all of destination data 121 stored in storage portion 102 are to be displayed, CPU 101 displays all of destination data 121 on display portion 109B. At step S34, CPU 101 displays destination data 121 on the basis of registration user information. In other words, destination data 121 having the same registration user information are classified in the same group, and destination data 121 is displayed for each group. At step S32, destination data is extracted where the log-in user is a registration user. However, destination data to which access is permitted within the authority of the log-in user may be extracted.

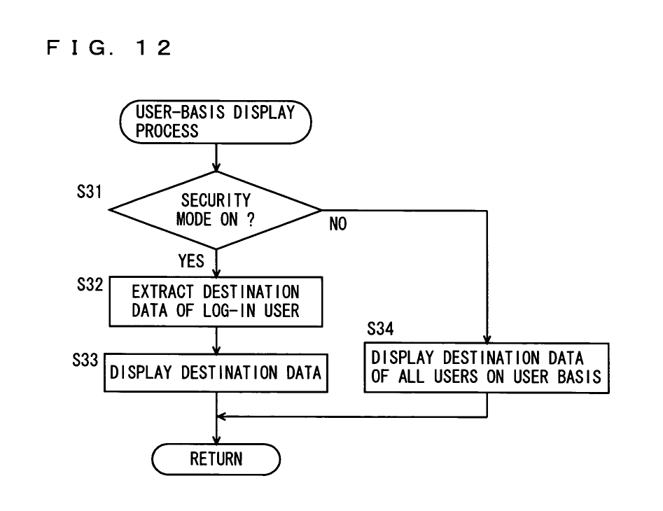

FIGS. 13A and 13B are diagrams showing exemplary display windows displayed when the user-basis display process is performed. FIG. 13A is diagram showing an exemplary display window displayed when a user having user identification information “Kodama” is authenticated. FIG. 13B is a diagram showing an exemplary display window displayed in the state of security mode OFF. In FIG. 13A, only destination data 121 whose registration user identification information is user identification information “Kodama” of the log-in user is displayed. In FIG. 13B, destination data 121 stored in storage portion 102 is displayed on the basis of registration user identification information. In the figure, only destination data 121 whose registration user identification information is “Kodama” is displayed, by way of example. Destination data 121 displayed here is destination user identification information. In order to switch to the display of destination data 121 of another registration user identification information, a tag representing another registration user identification information “Maekawa” is designated, thereby switching to the display of destination data 121 whose registration user identification information is “Maekawa”.

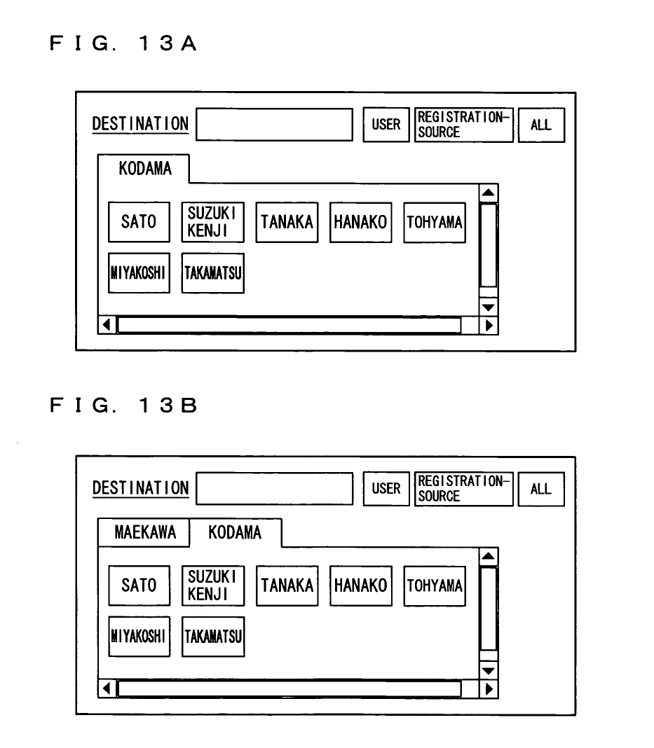

FIG. 14 is a flowchart illustrating an exemplary apparatus-basis display process. Referring to FIG. 14, the processes at step S41 and step S42 are the same as step S31 and step S32 shown in FIG. 12, respectively, and therefore description thereof will not be repeated here. At step S43, assuming that destination data 121 extracted at step S42 is to be displayed, CPU 101 displays destination data 121 on the apparatus basis on display portion 109B. Among destination data 121 to be displayed, CPU 101 classifies destination data 121 whose registration-source apparatus identification information are the same into the same group and displays destination data 121 for each group. On the other hand, at step S44, assuming that all of destination data 121 stored in storage portion 121 are to be displayed, CPU 101 displays all of destination data 121 on display portion 109B. At step S34, CPU 101 displays destination data 121 on the basis of registration-source apparatus identification information. In other words, destination data 121 having the same registration-source apparatus identification information are classified in the same group, and destination data 121 is displayed for each group.

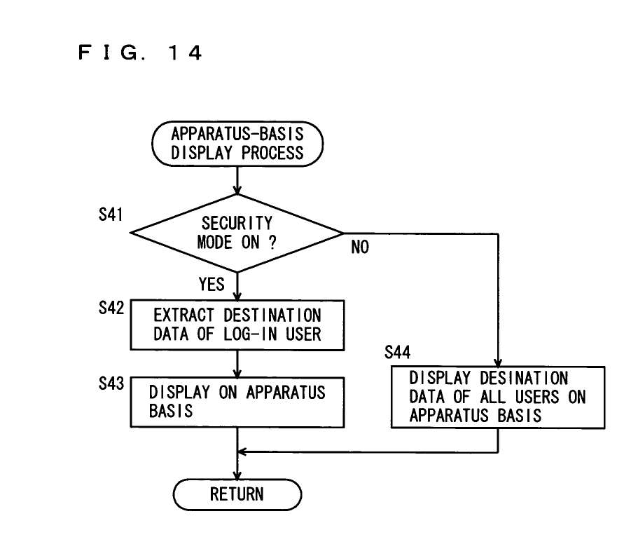

FIGS. 15A and 15B are diagrams showing exemplary display windows displayed when the apparatus-basis display process is performed. FIG. 15A is a diagram showing an exemplary display window displayed when user identification information “Kodama” is authenticated in the state of security mode ON. FIG. 15B is a diagram showing an exemplary display window displayed in the state of security mode OFF. In FIG. 15A, only destination data 121 whose registration user identification information is user identification information “Kodama” of the log-in user is displayed. Destination data 121 displayed here is destination user identification information. In addition, only the destination user identification information of the destination data whose registration-source apparatus identification information is “PC-A” is displayed. In order to switch to the display of destination data 121 of another registration-source apparatus identification information, a tag representing another registration-source apparatus identification information “mobile phone B” is designated, thereby switching to the display of destination data 121 whose registration-source apparatus identification information is “mobile phone B”.

In FIG. 15B, destination data 121 stored in storage portion 102 is displayed on the basis of registration-source apparatus identification information. In the figure, destination data 121 whose registration-source apparatus identification information is “PC-A” is displayed by way of example. Destination data 121 displayed here is destination user identification information. In order to switch to the display of destination data 121 of another registration-source apparatus identification information, a tag representing another registration-source apparatus identification information “mobile phone A” or “mobile phone B” is designated, thereby switching to the display of destination data 121 whose registration-source apparatus identification information is “mobile phone A” or the display of destination data 121 whose registration-source apparatus identification information is “mobile phone B”.

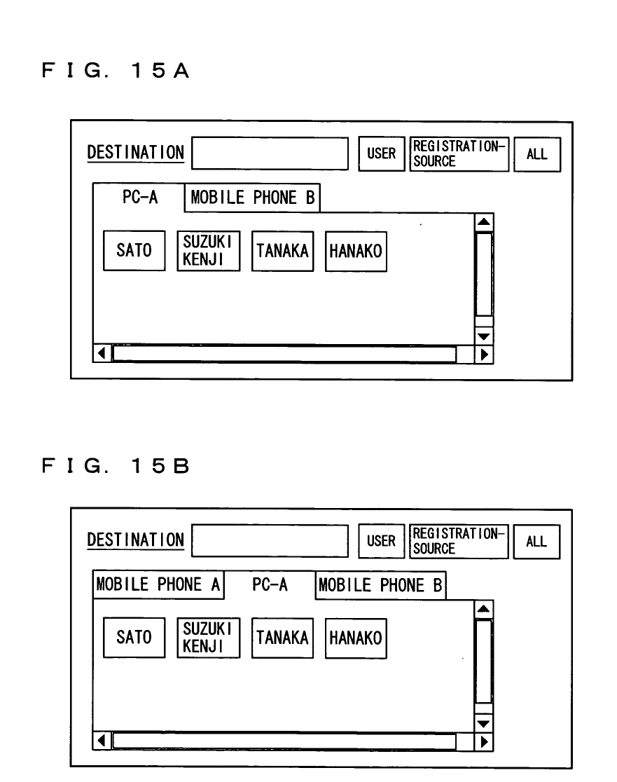

In the display window shown in FIG. 15A or FIG. 15B, the displayed destination user identification information is designated whereby the details of destination data including destination user identification information are displayed. FIG. 16 is a diagram showing an exemplary destination data display window. FIG. 16 shows a destination data display window displayed when destination user identification information “Hanako” is designated in FIG. 15A. Now referring to FIG. 10, there are two destination data that include registration user identification information “Kodama” and destination user identification information “Hanako”. Therefore, the destination data display window includes two destination data. In order to identify two destination data, the destination data display window displays address numbers “address 1” and “address 2” respectively assigned thereto. The destination data display window includes a region for selecting either identification information “address 1” or “address 2”. FIG. 16 shows that “2” is specified as the selected address number, by way of example. It is shown that the address number “address 2” is selected, and “hana@test.jp” is selected as a destination address.

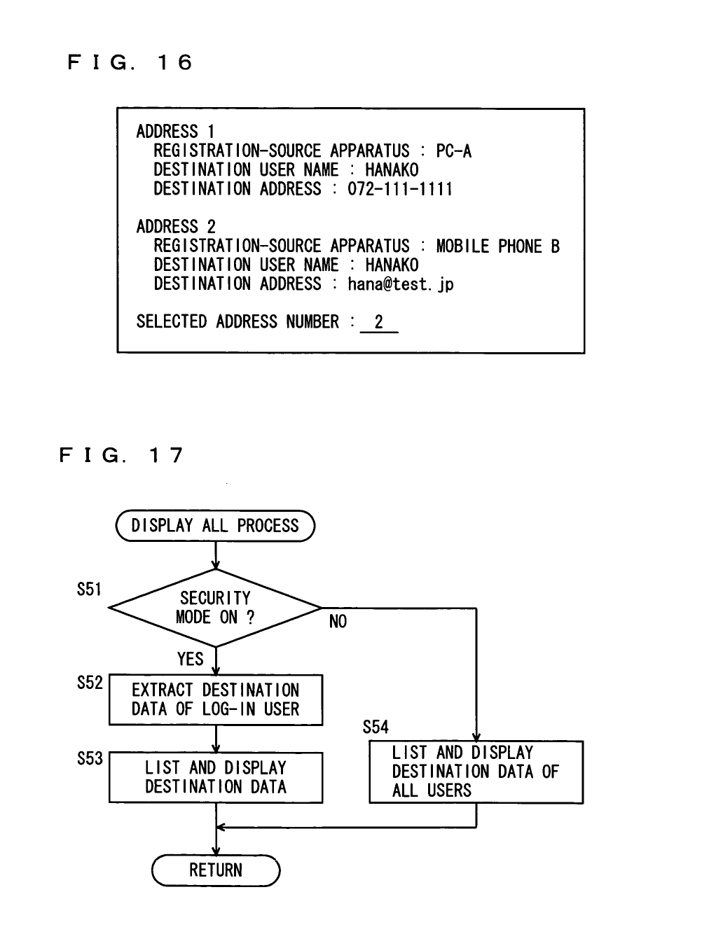

FIG. 17 is a flowchart illustrating an exemplary display all process. Referring to FIG. 17, the processes at step S51 and step S52 are the same as step S31 and step S32 shown in FIG. 12, respectively, and therefore description thereof will not be repeated here. At step S53, assuming that destination data 121 extracted at step S52 is to be displayed, CPU 101 displays destination data 121 on display portion 109B. On the other hand, at step S54, assuming that all of destination data 121 stored in storage portion 102 are to be displayed, CPU 101 displays all of destination data 121 on display portion 109B.

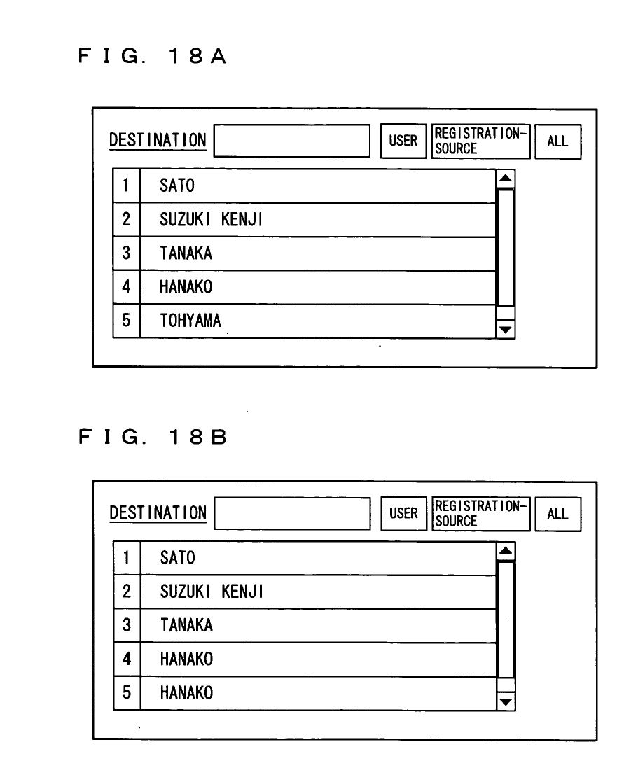

FIG. 18A and FIG. 18B are diagrams showing exemplary display windows displayed when the display all process is performed. FIG. 18A is a diagram showing an exemplary display window displayed when user identification information “Kodama” is authenticated in the state of security mode ON. FIG. 18B is a diagram showing an exemplary display window displayed in the state of security mode OFF. In FIG. 18A, only destination data 121 whose registration user identification information is user identification information “Kodama” of the log-in user are listed and displayed. In FIG. 18B, all of destination data 121 stored in storage portion 102 are listed and displayed. Destination data 121 displayed here is destination user identification information.

In the foregoing embodiment, registration user identification information is included in destination data. Alternatively, registration-source apparatus identification information and address data may be related with each other without including registration user identification information in destination data. In this case, registration user identification information needs not be received from computer 200 or mobile phones 211, 212. Thus, the destination data shown in FIG. 10 is data excluding the item of registration user identification information. In order to prevent registration of two destination data having the same registration-source apparatus identification information and destination user identification information, and in addition, in order to prevent registration of two destination data having the same registration-source apparatus identification information and destination address, in the destination data registration process in FIG. 7, at step S08, destination data having the same registration-source apparatus are extracted. Then, at step S09, the received address data is compared with all of the registered destination data to determine whether or not the destination user identification information and destination address are the same. At step S10, the received address data is compared with all of the registered destination data to determine whether or not either one of destination user identification information and destination address is the same. More specifically, when address data is received from an apparatus, if destination data which includes registration-source apparatus identification information assigned to the apparatus that transmitted the address data and which has the same destination user identification information and destination address as included in the address data is not registered in the already-registered destination data, destination data is additionally registered anew which is formed of the address data received from the apparatus and registration-source apparatus identification information assigned to the apparatus that transmitted the address data (the apparatus that has stored the address data). Furthermore, when address data is received from an apparatus, if destination data which includes registration-source apparatus identification information assigned to the apparatus that transmitted the address data and which has at least one of the same destination user identification information and destination address as included in the address data has already been registered in the already-registered destination data, the address data (destination user identification information and destination address) of that destination data is changed to the address data received from the apparatus.

Furthermore, in displaying destination data, destination data cannot be extracted using registration user identification information as a key. More specifically, step S23 and step S24 shown in FIG. 11 are not performed, and if the user is authenticated at step S22, the process proceeds to step S25. In addition, the user-basis display process shown in FIG. 12 is not performed. Moreover, in the apparatus-basis display process shown in FIG. 14, destination data of all users are displayed on the apparatus basis, irrespective of the security mode. Furthermore, in the display all process shown in FIG. 17, destination data of all users are listed and displayed, irrespective of the security mode.

As described above, MFP 100 in accordance with the present embodiment includes: address data obtaining portion 151 obtaining address data in which destination user identification information for identifying a destination user and a destination address for specifying a destination are related with each other and registration-source apparatus identification information of an apparatus that outputs the address data; and destination data registration portion 152 registering the destination data in which the obtained address data and the obtained registration-source apparatus identification information are related with each other, for storage into storage portion 102. Therefore, the address data input from computer 200, mobile phone A211, mobile phone B212 can be registered and stored in MFP 100 in relation with registration-source apparatus identification information. Therefore, the user can use the familiar address in each apparatus also in MFP 100 with the familiar state being kept.

If such destination data has already been stored in that registration-source apparatus identification information obtained together with address data is included and only one of destination user identification information and destination address matches that of the address data, destination data registration portion 152 changes the address data of the stored destination data to the obtained address data. Therefore, for example, even if the address data of mobile phone A211 is changed, that change can be reflected in the destination data of MFP 100.

On the other hand, if such destination data is not stored in that registration-source apparatus identification information obtained together with address data is included and at least one of destination user identification information and destination address matches that of the address data, destination data registration portion 152 additionally registers and stores into storage portion 102 destination data in which the obtained address data and the obtained apparatus identification information are related with each other. Therefore, even if address data is added in mobile phone A211, that addition can be reflected in the destination data of MFP 100.

Furthermore, MFP 100 includes: address data obtaining portion 151 obtaining address data in which destination user identification information for identifying a destination user and a destination address for specifying a destination are related with each other, registration-source apparatus identification information of an apparatus that outputs the address data, and registration user identification information for identifying a user who gave an instruction to obtain address data; and destination data registration portion 152 storing into storage portion 102 the destination data in which the obtained address data, the obtained registration-source apparatus identification information, and the obtained registration user identification information are related with one another. Therefore, the address data input for each user at computer 200, mobile phone A211, mobile phone B212 can be stored in MFP 100.

If such destination data has already been stored in that registration-source apparatus identification information and registration user identification information obtained together with address data are included and only one of destination user identification information and destination address matches that of the address data, destination data registration portion 152 changes the address data of the stored destination data to the obtained address data. Therefore, for example, even if the address data of mobile phone A211 is changed, that change can be reflected in the destination data of MFP 100.

On the other hand, if such destination data is not stored in that registration-source apparatus identification information and registration user identification information obtained together with address data are included and at least one of destination user identification information and destination address matches that of the address data, destination data registration portion 152 additionally registers and stores into storage portion 102 destination data in which the obtained address data, the obtained apparatus identification information and the obtained registration user identification information are related with one another. Therefore, even if address data is added in mobile phone A211, that addition can be reflected in the destination data of MFP 100.

Moreover, destination data having the same registration-source apparatus identification information or registration user identification information are classified into the same group, so that the destination information of the destination data is displayed for each group, thereby facilitating selection of a desired destination data. In particular, even if destination data is increased in number, the number of displayed destination data is reduced, thereby facilitating selection.

Moreover, an input of authentication information for authenticating a user is accepted. If user authentication is successful, destination data including user identification information assigned to the authenticated user as registration user identification information is displayed. If authentication is failed, destination data is not displayed so that destination data is not seen by others thereby improving security.

It is noted that although in the present embodiment MFP 100 has been described, it is needless to say that the present invention can be understood as a method of allowing MFP 100 to perform the destination data registration process shown in FIG. 7 or the address display process shown in FIG. 11, FIG. 12, FIG. 14 and FIG. 17 and a destination data management program executed in CPU 101 to allow MFP 100 to perform the destination management process or the address display process.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A information processing apparatus comprising:
a obtaining portion for obtaining address data from an apparatus, said address data including destination user identification information identifying a destination user and destination information identifying a destination;
a obtaining portion for obtaining apparatus identification information identifying the apparatus;
a registration portion for registering destination data in relation with said obtained address data and said obtained apparatus identification information; and
a storing portion for storing said destination data registered by said registration portion.

2. The information processing apparatus as claimed in claim 1, further comprising a display portion for reading said destination data from said storing portion, for classifying said destination data which have same apparatus identification information to the same group and for displaying said destination information of said destination data separately by each said group.

3. The information processing apparatus as claimed in claim 2, wherein said display portion classifies said destination data which apparatus identification information is same each other into the same group and displays said destination information of said destination data by each said group.

4. The information processing apparatus as claimed in claim 1, when said destination data includes said obtained apparatus identification information, and said destination data which only either said destination user identification information or said destination information is the same as said obtained address data is registered, said registration portion updates the address data of said registered destination data to said obtained address data.

5. The information processing apparatus as claimed in claim 4, wherein,
when a destination data includes said obtained apparatus identification information and said obtained registration user identification information, and the destination data which only either said destination user identification information or said destination information is the same as said obtained address data is registered, said updating portion updates the address data of said registered destination data to said obtained address data.

6. The information processing apparatus as claimed in claim 1,
when said destination data includes said obtained apparatus identification information, and said destination data which only either said destination user identification information or said destination information is the same as said obtained address data is not registered, said registration portion additionally registers said obtained address data as a destination data in relation with said obtained apparatus identification information.

7. The information processing apparatus as claimed in claim 6, wherein,
when a destination data includes said obtained apparatus identification information and said obtained registration user identification information, and the destination data which only either said destination user identification information or said destination information is the same as said obtained address data is not registered, said additionally registering portion additionally registers said obtained address data as a destination data in relation with said obtained apparatus identification information.

8. The information processing apparatus as claimed in claim 1, further comprising an authentication portion of receiving an authentication information for user authentication and authenticating user;
in the case where said authentication by said authentication portion succeeds, said destination data including said authentication user identification information is displayed,
in the other case where said authentication does not succeed, said destination data is not displayed.

9. A information processing apparatus comprising:
a obtaining portion for obtaining address data from an apparatus, said address data including destination user identification information identifying a destination user and destination information identifying a destination;
a obtaining portion for obtaining apparatus identification information identifying the apparatus;
a obtaining portion for obtaining registration user information identifying a user registered said address data;
a registration portion for registering destination data in relation with said obtained address data and said obtained apparatus identification information; and
a storing portion for storing said destination data registered by said registration portion.

10. The information processing apparatus as claimed in claim 9, further comprising a display portion for reading said destination data from said storing portion, for classifying said destination data which have same apparatus identification information to the same group and for displaying said destination information of said destination data separately by each said group.

11. The information processing apparatus as claimed in claim 10, further comprising a obtaining portion for obtaining display condition, wherein
the first method of classifying said destination data which apparatus identification information is same each other into the same group and the second method of classifying said destination data which user identification information is same each other into the same group are switched by said display portion according to said obtained display condition.

12. The information processing apparatus as claimed in claim 9, wherein,
when said destination data includes said obtained apparatus identification information, and said destination data which only either said destination user identification information or said destination information is the same as said obtained address data is registered, said registration portion updates the address data of said registered destination data to said obtained address data.

13. The information processing apparatus as claimed in claim 9, wherein,
when said destination data includes said obtained apparatus identification information, and said destination data which only either said destination user identification information or said destination information is the same as said obtained address data is not registered, said registration portion additionally registers said obtained address data as a destination data in relation with said obtained apparatus identification information.

14. The information processing apparatus as claimed in claim 9, further comprising an authentication portion of receiving an authentication information for user authentication and authenticating user;
in the case where said authentication by said authentication portion succeeds, said destination data including said authentication user identification information is displayed, in the other case where said authentication does not succeed, said destination data is not displayed.

15. The information processing apparatus as claimed in claim 14, wherein said display portion classifies said destination data which apparatus identification information is same each other into the same group and displays said destination information of said destination data by each said group.

16. A computer program embodies in a computer readable medium for performing the steps of
obtaining address data from an apparatus, said address data including destination user identification information identifying a destination user and destination information identifying a destination;
obtaining apparatus identification information identifying the apparatus;
registering destination data in relation with said obtained address data and said obtained apparatus identification information.

17. The computer program as claimed in claim 16, further comprising the step of
reading said destination data from said storing portion;
classifying said destination data which have same apparatus identification information to the same group;
displaying said destination information of said destination data separately by each said group.

18. The computer program as claimed in claim 16, further comprising the step of:
receiving an authentication information for user authentication and authenticating user;
in the case where said authentication succeeds, said destination data including said authentication user identification information is displayed,
in the other case where said authentication does not succeed, said destination data is not displayed.

19. A computer program embodies in a computer readable medium for performing the steps of
obtaining address data from an apparatus, said address data including destination user identification information identifying a destination user and destination information identifying a destination;
obtaining apparatus identification information identifying the apparatus;
obtaining registration user information identifying a user registered said address data;
registering destination data in relation with said obtained address data and said obtained apparatus identification information.

20. The computer program as claimed in claim 19, further comprising the step of:
reading said destination data from said storing portion;
classifying said destination data which have same apparatus identification information to the same group;
displaying said destination information of said destination data separately by each said group.

21. The computer program as claimed in claim 19, further comprising the step of:
receiving an authentication information for user authentication and authenticating user;
in the case where said authentication succeeds, said destination data including said authentication user identification information is displayed,
in the other case where said authentication does not succeed, said destination data is not displayed.
